(19) United States
(12) Patent Application Publication
(10) Pub. No.: US 2020/0120940 A1
(43) Pub. Date: Apr. 23, 2020

(54) METHODS AND SYSTEMS OF FOOD PREPARATION

(71) Applicant: Spellbound Development Group, Inc., Irvine, CA (US)

(72) Inventors: Earl Joseph Votolato, Newport Beach, CA (US); Carlos David Reyes, Rancho Santa Margarita, CA (US); Amanda Jeanne Brooks, Santa Ana, CA (US); Ryan Michael Burkes, Huntington Beach, CA (US)

(21) Appl. No.: 16/600,926

(22) Filed: Oct. 14, 2019

Related U.S. Application Data
(60) Provisional application No. 62/748,964, filed on Oct. 22, 2018.

(51) Int. Cl. A21B 3/15; A23L 5/10

(52) U.S. Cl. CPC A21B 3/15; A23L 5/12

(57) ABSTRACT

A food sheet is disclosed for use in connection with the preparation of a food product. One example food sheet is disclosed to include a base material that is dissolvable at a predetermined environmental condition and a grease agent contained within the base material. The grease agent is released from the base material when the base material dissolves and then provides a baking or cooking lubrication for the food product.

### CROSS-REFERENCE TO RELATED APPLICATION

This application claims the benefit of priority under 35 U.S.C. § 119(e) to U.S. Provisional Patent Application 62/748,964, filed Oct. 22, 2018, the entirety of which is incorporated herein by reference.

### TECHNICAL FIELD

The present disclosure is directed generally toward food preparation systems and methods and more particularly toward systems and methods for enabling the flavoring and/or lubrication of food and/or food cooking surfaces.

### BACKGROUND

Food service companies face a challenge in pizza preparation and cooking as well as more general food baking, preparation, and/or cooking. For instance, in pizza preparation, when a pizza is made to order, a cook prepares the dough, adds toppings, and places the uncooked pizza into a hot oven. There are times when the pizza is cooked on a pan and this pan may require a release agent and or material to ensure the cooked pizza does not stick to the pan. This may be some type of lubricant.

Some chefs use cornmeal or semolina which acts similar to ball-bearings by lessening the friction between the uncooked dough and the cooking pan. Cornmeal and/or semolina, however, sticks to the dough on the bottom of the pizza and adds texture and alters the taste of the pizza. This side effect may be unwanted in many cases. Also, cornmeal and/or semolina can fall onto the hot surface of the oven and burn and can fall off the cooking pan and/or work counter onto the floor creating a mess and slippery floors. Cornmeal and/or semolina is difficult to clean. Cornmeal also presents some safety concerns relative to slips and falls in and around the food preparation areas.

With situations where the pizza or other food product is cooked in or on the cooking pan, most chefs will use oil or grease (e.g., shortening) as the mechanism to ensure that the pizza dough does not stick to the cooking pan after baking. The use of the oil introduces many inefficiencies into a pizza line, which is often required to operate with as much efficiency as possible. On the flip side, the use of certain oils still provides the benefit imparting a specific texture to the pizza crust such as crunchiness or to impart a slight flavoring of fried dough to the external surface. Notwithstanding the above, the use of oil presents opportunities for messes and has a number of hazards associated therewith. Such hazards include slips and falls due to oily floors, and back injuries associated with carrying bulk packaged oils (e.g., 5-gallon) containers of cooking oils. Other alternatives might include using non-stick pan solutions (e.g., pans coated with PTFE, silicone, or the like). The downside to using non-stick pans, especially in a restaurant or commercial food scenario, is that the pans are significantly more expensive and susceptible to damage than traditional pans.

### DRAWINGS

For a more complete understanding of the present disclosure and its advantages, reference is now made to the following description taken in conjunction with the accompanying drawings, in which like reference numerals represent like parts:

FIG. 1A illustrates a food sheet in accordance with one or more embodiments described herein;

FIG. 1B illustrates a food sheet in accordance with one or more embodiments described herein;

FIG. 1C illustrates a food sheet in accordance with one or more embodiments described herein;

FIG. 2A illustrates a food sheet on a pizza cooking pan in accordance with one or more embodiments described herein;

FIG. 2B illustrates a food sheet on a pizza cooking pan in accordance with one or more embodiments described herein;

FIG. 2C illustrates a food sheet on a pizza cooking pan in accordance with one or more embodiments described herein;

FIG. 3 is a flowchart of a food preparation method in accordance with one or more embodiments described herein;

FIG. 4 is a flowchart of another food preparation method in accordance with one or more embodiments described herein;

FIG. 5 is a flowchart of another food preparation method in accordance with one or more embodiments described herein;

FIG. 6 is a flowchart of another food preparation method in accordance with one or more embodiments described herein;

FIG. 7 illustrates a food sheet in accordance with one or more embodiments described herein;

FIG. 8 illustrates another food sheet in accordance with one or more embodiments described herein;

FIG. 9 illustrates another food sheet in accordance with one or more embodiments described herein; and

FIG. 10 illustrates another food sheet in accordance with one or more embodiments described herein.

### DESCRIPTION

It is with respect to the above-noted challenges and shortcomings that embodiments of the present disclosure were contemplated.

Because of the above discussed issues, food preparation companies need a simple, clean and efficient and food-safe solution to address these challenges while still offering a solution to assist in the food preparation process. As a more specific example, it is desirable to develop a mechanism for properly cooking pizza while still enabling the release of a pizza from the cooking pan. What is needed is an approach that addresses the challenges while maintaining efficiencies of the food preparation line.

In the food preparation process, for both commercial and/or private kitchens, there is a need to control contaminants and the quality of food products utilized in the preparation of food to be served. Part of this process involves the preparation of cooking surfaces, imparting of flavors, and controlling of seasoning to the food.

It is with respect to the issues and other problems presently faced by those of skill in the relevant art and described above that the embodiments presented herein are contemplated. To this end, a novel approach is described herein. The devices and methods described herein provide for a cleaner, controllable, and efficient food preparation process by improving and aiding in the lubrication, seasoning, and/or flavoring of foods and liquids.

Benefits of food sheets as described herein may include but are not limited to: maximizing efficiency of food preparation process by speeding it up; simplifying the food preparation process by taking out the need to search for ingredients and combining them into a mix suitable for the flavor profile needed; minimizing cross-contamination issues associated with food preparation; minimizing the risk to customer eating a food product by providing a safe solution to food allergies; minimizing packaging waste because food sheets would be entirely edible and certainly biodegradable; minimizing difficulty of maintaining clean cooking areas/kitchens, minimizing hazards and associated costs of slip and fall and back injuries using cooking ingredients that may be heavy to handle and also might end up on floor causing a slippery surface; and minimizing the overall cost of producing food by savings on ingredients and preparation time (man hours).

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The ensuing description provides embodiments only and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims. Specific details were given in the description to provide a thorough understanding of the embodiments. However, it will be understood by one of ordinary skill in the art that the embodiments may be practiced without these specific details.

In embodiments described herein, a food sheet may correspond to a food-safe and edible product. In some embodiments, the food sheet may comprise one or more of a starch, gelatin, agar, grain, rice, fruit, and/or vegetable. The food sheet may be a raw product, cooked, processed, freeze-dried, etc. The food sheet may comprise natural and/or artificial flavoring. The food sheet may comprise natural and/or artificial coloring. The food sheet may be capable of dissolving when applied with heat and/or liquid/moisture. Alternatively or additionally, the food sheet may correspond to a matrix of a dissolvable and edible substrate having one or more of a greasing agent (e.g., oil, lipid, shortening, butter, etc.) integrated therein. Alternatively or additionally, the food sheet may comprise an edible and/or dissolvable fiber-based structure into which a greasing agent and/or flavoring is impregnated.

In some embodiments, the food sheet may be in the form of a relatively thin film. For example, the food sheet may have a depth of no larger than a centimeter or two. In some embodiments, a food sheet may be very thin and in other embodiments, a food sheet may be relatively thick (e.g., thicker than 10 centimeters). The food sheet, in some embodiments, may be in various shapes depending on intended or expected use. For example, a food sheet may be circular, rectangular, or in odd shapes. In some embodiments, a food sheet may be perforated to be torn into needed amounts by a user. In some embodiments, the food sheet may have a thin, but three-dimensional shape that can conform to common cooking device shapes, which may or may not be planar (e.g., a dish, baking tin, baking pan, or other type of cooking vessel).

In some embodiments, a food sheet may comprise an edible or non-edible substrate or carrier sheet. For example, a food sheet may comprise a thin layer of one or more of a fiber, starch, gelatin, agar, grain, rice, fruit, and/or vegetable. The thin layer may be placed on an edible or non-edible substrate or carrier sheet such as a paper, a plastic, a baking vessel (e.g., a metal, ceramic, or glass dish) or another one or more of a starch, gelatin, agar, grain, rice, fruit, and/or vegetable. The substrate or carrier sheet may be used for packaging and/or handling the food sheet. In some embodiments, the substrate or carrier sheet may be removed by a user prior to the food sheet being used in the preparation of food. In some embodiments, the substrate or carrier sheet may be optionally used by a user in the preparation of food. In some embodiments, a substrate or carrier sheet of a food sheet may be a heat and/or liquid-dissolvable substrate or carrier sheet. In some embodiments, a food sheet may be impregnated or embedded within a surface of a substrate (e.g. fibers) and may comprise food safe ingredients such as cooking oil, flavoring or seasonings or a combination of the same.

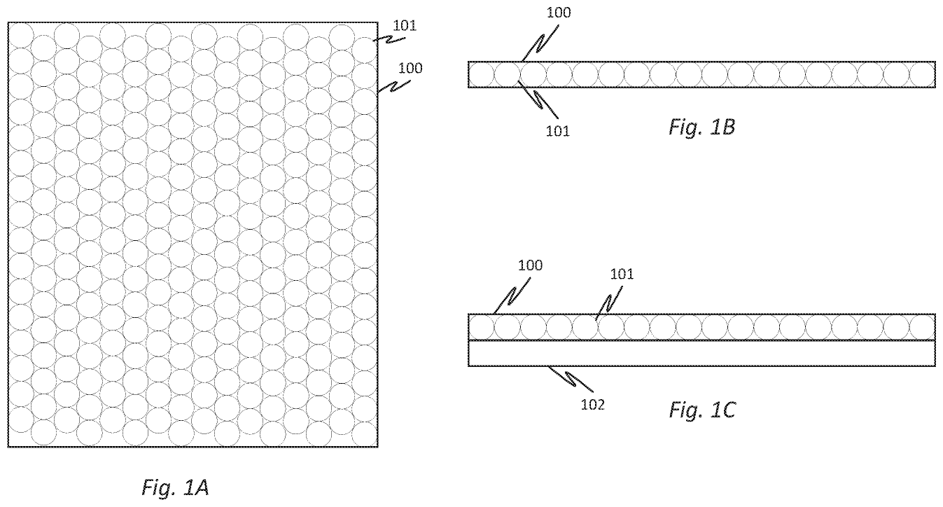

In some embodiments, a food sheet may comprise an edible material embedded with encapsulated food-safe ingredients such as cooking oil, flavorings, or seasonings or a combination thereof. For example, a food sheet 100 may comprise one or more micro-gel capsules 101 configured in a matrix shape as illustrated in FIG. 1A. Micro-gel capsules 101 configured in a matrix shape may be similar to a sheet of bubble packaging. Each individual capsule 101 may comprise a single material therein or may comprise a mixture of materials. For example, an individual capsule 101 may solely comprise a greasing agent. As another example, an individual capsule 101 may solely comprise a flavoring and/or seasoning. In some embodiments, one or more capsules 101 may comprise a combination of a greasing agent, flavoring, and/or seasoning. It should be appreciated that a predetermined area of the food sheet 100 may have a predetermined number of capsules 101 (e.g., 400 capsules per square meter). It may be possible to distribute different fillings among the array of capsules to achieve a desired flavoring profile and/or greasing profile. As a non-limiting example, embodiments of the present disclosure contemplate filling more than 70% of the capsules 101 in a given area with a greasing agent whereas the remaining 30% of the capsules 101 in the same area may be filled with a flavoring and/or seasoning. The amount and proportions of greasing agent used as compared to flavoring and seasoning can be adjusted to accommodate baking needs and temperatures of particular baking ovens, the diffusivity of the material of the capsules 101, a desired flavor profile, and other concerns. Said another way, embodiments of the present disclosure should not be construed as being limited to a particular ratio or proportioned use of greasing agent versus flavoring/seasoning.

As illustrated in FIG. 1B, the capsules 101 may lie flat in a horizontal plane. In some embodiments, the material of the capsules 101 may be entirely edible. For example, capsules 101 may be similar to vitamin gel caps but smaller and may be constructed of vegetable materials, starches, or a combination thereof. The capsules 101, as discussed above, may be filled with food safe ingredients such as cooking oil, flavorings, or seasonings or a combination thereof. The capsules 101 may be of a material designed to dissolve or disintegrate at a particular temperature and/or in response to exposure to a predetermined amount of moisture. For example, the capsules 101 may be designed to melt or dissolve when temperatures above 190 degrees Fahrenheit are applied thereto, thus releasing the food safe ingredients encapsulated therein. In some embodiments, the capsules 101 may be designed to disintegrate and release their contents when in contact with a liquid or moisture, which may be inherently present in the food being cooked (e.g., a pizza dough under which the sheet 100 is placed).

In some embodiments, as illustrated in FIG. 1C, a food sheet 100 may comprise an edible or non-edible substrate 102 or carrier sheet. For example, a food sheet 100 may comprise a thin layer of one or more of a fiber, starch, gelatin, agar, grain, rice, fruit, and/or vegetable. The thin layer may be placed on an edible or non-edible substrate 102 or carrier sheet such as a paper, a plastic, wax paper, silicone-coated paper, or another one or more of a starch, gelatin, agar, grain, rice, fruit, and/or vegetable. The substrate 102 or carrier sheet may be used for packaging and/or handling the food sheet. In some embodiments, the substrate 102 or carrier sheet may be removed by a user prior to the food sheet 100 being used in the preparation of food. In some embodiments, the substrate 102 or carrier sheet may be optionally used by a user in the preparation of food. In some embodiments, a substrate 102 or carrier sheet of a food sheet may be a heat and/or liquid-dissolvable substrate or carrier sheet. In some embodiments, a food sheet may be impregnated or embedded within a surface of a substrate (e.g. fibers) and may comprise food safe ingredients such as cooking oil, flavoring or seasonings or a combination of the same.

In some embodiments, a food sheet may be used to apply or print flavor and or food preparation oils and ingredients directly onto food or a combination of the food product and the sheet 100. For example, a food sheet 100 may be flavored with a oregano flavor that is directly applied to the food sheet 100 via an inkjet printing process. The food sheet may be such that it dissolves or disintegrates when heat is applied. In this way, when an oregano flavored food sheet is placed on a warm pizza, the oregano flavored food sheet may disintegrate and release oregano flavor across the surface of the warm pizza. Similarly, an olive oil-type food sheet may be such that it disintegrates when placed between raw pizza dough and a pizza cooking pan. Such a food sheet may be used to aid in the preparation of a pizza by lubricating the bottom of the dough to prevent the dough from sticking to the cooking pan before the dough is slid into an oven.

In some embodiments, a food sheet may function at a typical room temperature range, warm and or cold environment and could be stored in the same or similar manner. For example, a food sheet may be stable at room temperatures but when applied with one or more of a warm or cold temperature the food sheet may break down and release its flavors and/or other contents provided therein.

In some embodiments, a food sheet may be made so that it has a flexibility between very flexible (e.g. similar to a sheet of paper) and stiff (e.g. similar to a thick sheet of cardboard). This flexibility could be a function of the structure, temperature, chemical nature, and/or product design of the food sheets.

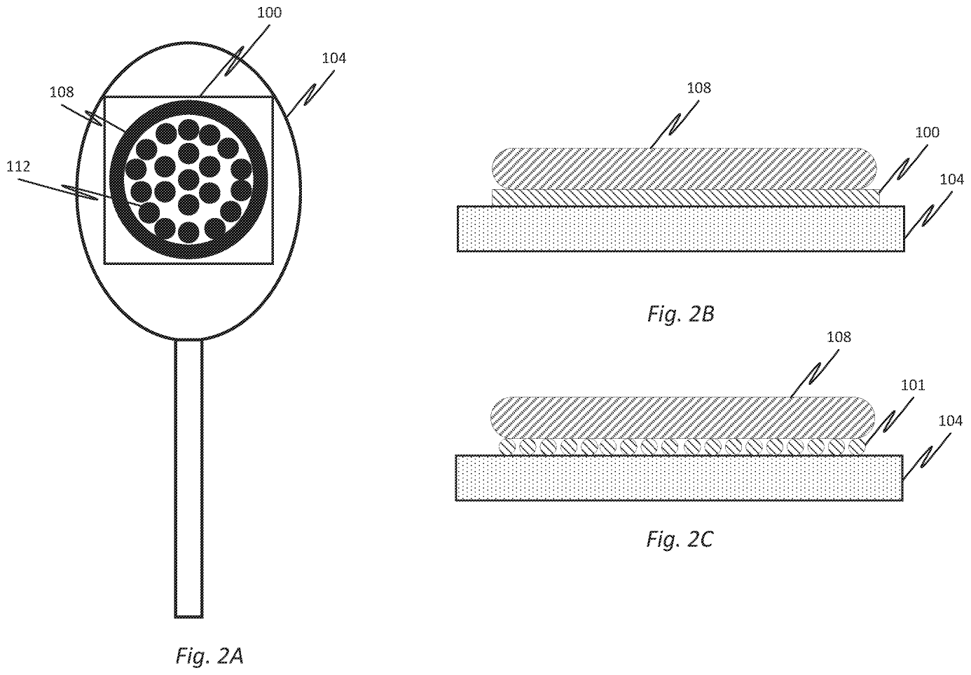

In some embodiments, a food sheet 100 may be used to prepare a pizza as illustrated in FIGS. 2A-2C.

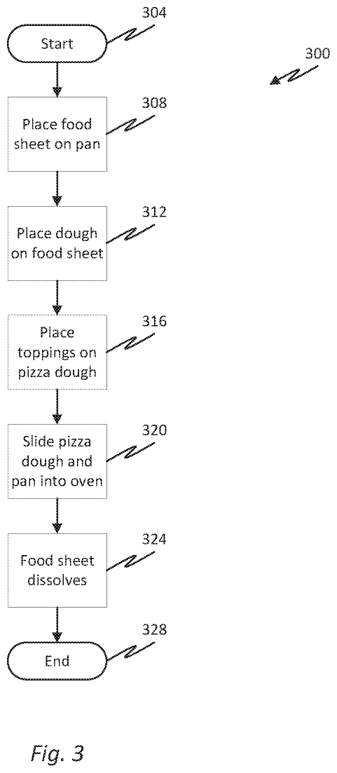

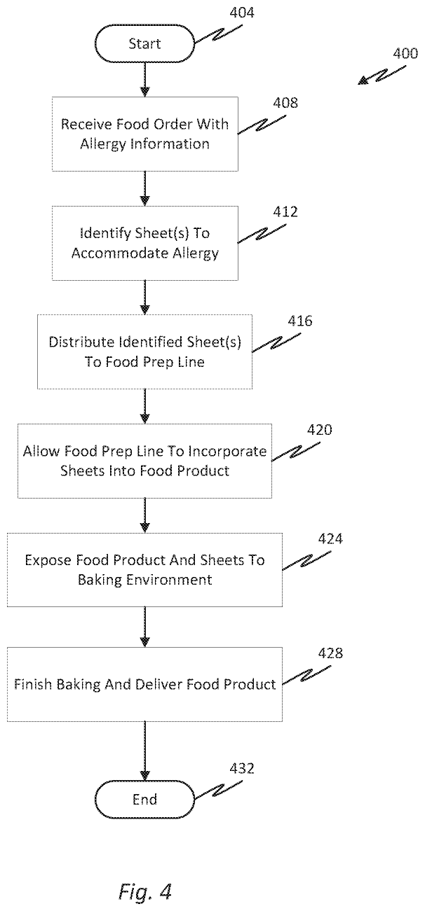

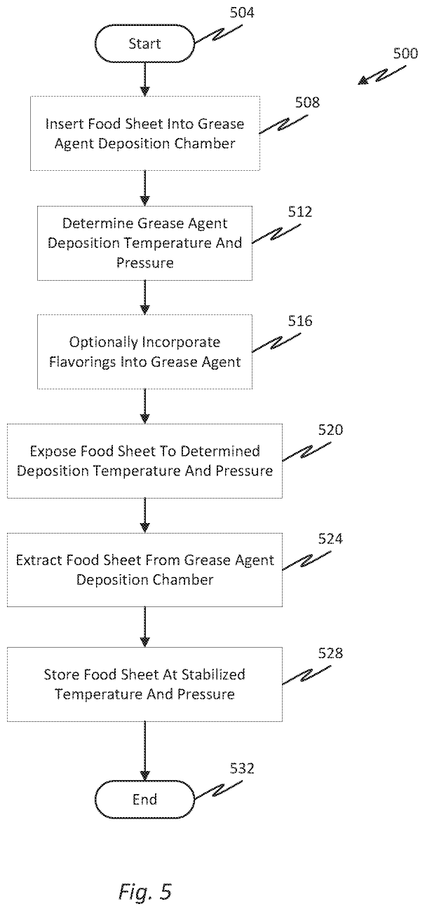

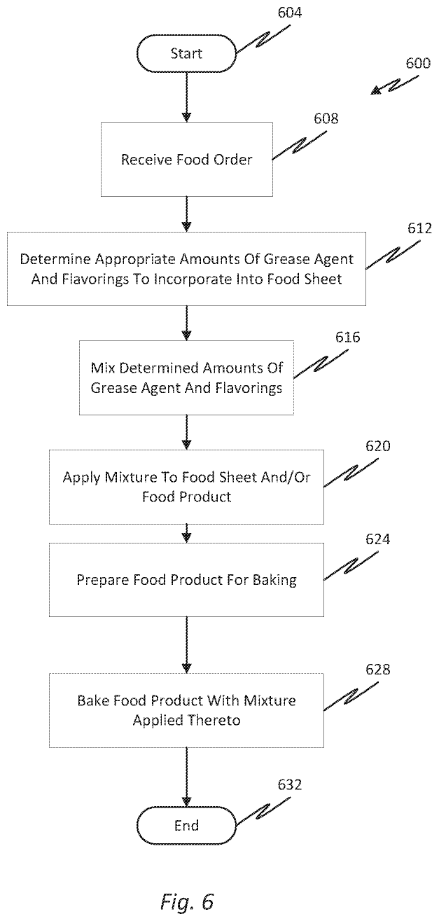

With reference now to FIGS. 3-6, various food preparation methods will be described in accordance with at least some embodiments of the present disclosure. It should be appreciated that the various methods and steps depicted therein may be performed in connection with preparing a food product and with the assistance of a food sheet 100, for instance. It should also be appreciated that any of the steps of any method may be used in combination with other methods depicted and described herein. For instance, steps from FIG. 3 or 4 may be performed in connection with a method depicted and described in connection with any of FIGS. 5 and 6. Likewise, steps from FIGS. 5 and 6 may be performed in connection with the methods depicted and described in FIG. 3 and/or 4 without departing from the scope of the present disclosure.

According to some embodiments, a user may prepare to cook a pizza following a method 300 as described in FIG. 3. The method 300 may begin in step 304. Thereafter, a user may select a cooking oil food sheet 100 and simply lay the food sheet 100 on a pizza cooking pan 104 or within the area of a pizza pan or similar type of cooking vessel (step 304). After the food sheet 100 is placed on a cooking pan 104, the user may next prepare the dough 108 for the pizza (step 308). Once the dough 108 is prepared, the user may lay the dough 108 onto the food sheet 100 on the cooking pan 104 (step 312). Once the dough 108 is on the food sheet 100 on the cooking pan 104, the user may place toppings 112 on the dough 108 (step 316) and prepare the pizza for eventual placement into a cooking oven. As the dough 108 sits upon the food sheet 100, at least some of the food sheet 100 (e.g., the dissolvable portions thereof) may begin to dissolve under the dough 108 and release discrete amounts of a grease agent and/or flavoring that were previously contained within the tiny pockets or capsules 101. This initial dissolving and release of contents may occur in response to contact with moisture from the pizza dough 108. The method 300 then proceeds with the pizza dough and pan being placed into the oven for baking (step 320). The application of heat to the food sheet may cause the food sheet or the capsules 101 provided in the food sheet to dissolve or further dissolve (Step 324). Thus, one or more of cooking oil and flavors may be deposited onto the top surface of the cooking pan 104 and the bottom surface of the pizza dough 108. The released contents of the tiny pockets or capsules 101 may create a low friction layer enabling the pizza dough 108 to easily slide off or be removed from the cooking pan 104 after the baking has been completed. After baking, the pizza may be removed from the oven and consumed. The above-described process results in a flavorful and properly shaped pizza that can be efficiently made without the unwanted problems associated with using separate cooking oils or cooking substances in a bulk fashion.

While particular processes for processing food products, such as pizza, it should be appreciated that there many different ways to process pizza and other foods. For instance, embodiments of the present disclosure contemplate a food preparation method such as placing the food sheet 100 on the cooking pan, placing food on top of the food sheet 100 and the cooking pan, and then refrigerating the combination of the food product, food sheet 100, and pan together until the food product needs cooking. This particular approach enables the food product to be pre-positioned on the food sheet 100 and on the pan, thereby enabling the chef to quickly and easily place the food product, sheet 100, and pan into the oven when needed and without further steps.

With reference now to FIG. 4, another method 400 of food preparation will be described in accordance with at least some embodiments of the present disclosure. The method 400 begins at step 404 and continues when a customer provides food allergy information as part of a food order (step 408). The food allergy information may be received at an order or POS terminal and may then be communicated to a food preparation line. Alternatively or additionally, the food allergy information may be received at a mobile ordering application, which may be operated by the consumer's mobile communication device.

Upon receiving the allergy information from the customer, the method 400 continues with the food preparation line identifying one or more sheet(s) that should be used (or avoided) to accommodate the food allergy identified in the order (step 412). In some embodiments, individual food sheets 100 may be provided with discrete ingredients and a full order not identifying any allergies may utilize a predetermined combination of different sheets. For instance, a first sheet may be placed on top of a second sheet and third sheet to fulfill a complete and allergy-free order for a food product, such as pizza. As a non-limiting example, the first sheet 100 may contain or be impregnated with a grease agent (e.g., an oil, shortening, etc.), the second sheet 100 may contain or be impregnated with a flavoring, and the third sheet 100 may contain or be impregnated with a seasoning. If multiple seasoning and/or flavors are desired, then additional food sheets 100 may be used without departing from the scope of the present disclosure.

Continuing the above example, if a customer identifies an allergy to contents of a particular food sheet (e.g., the second food sheet 100), then the food line may determine that the order for this particular customer should not include the second food sheet (step 412). In some embodiments, any food sheets containing an allergen identified by the customer may be omitted from the combination of food sheets that are used to complete the order. By providing discrete ingredients on individual food sheets, embodiments of the present disclosure can enable a food line to efficiently and safely prepare a food product for the customer by simply not including the problematic food sheet. Because the various allergens are contained in different food sheets, the possibilities of cross-contamination during preparation of the food product is greatly reduced.

The method 400 continues by distributing the identified sheet(s) to the food line for preparation of the food product (step 416). In some embodiments, the various identified food sheets may be automatically distributed to the food line by an automated food sheet dispenser. In some embodiments, a particular set of labels may be followed by the food line personnel to ensure that the identified sheets are used for preparation of the food product and not the food sheets that contain the ingredients identified by the customer as being an allergen.

The food line is then allowed to incorporate the distributed food sheets into the food product (step 420). For instance, the food sheets may be sequentially placed one on top of another and all on top of a pizza pan or baking dish. The pizza dough may then be placed on top of the stack of food sheets, which will all be configured to dissolve when exposed to the heat of the oven and/or moisture of the pizza dough (step 424). In this particular example, the food product may be baked with the food sheets positioned in-situ such that the contents of the food sheets may be allowed to distribute between the dough and the pizza pan (e.g., to provide a lubrication therebetween) and to allow the various flavorings and/or seasonings to enter into the pizza dough itself.

In some embodiments, the ordering of the sheets in the stack of sheets may depend upon the contents of each sheet. As a non-limiting example, it may be desirable to provide the food sheet having the grease agent as the lower-most sheet (e.g., in closest proximity to the pizza pan) whereas the other food sheet(s) having the flavorings and/or seasonings may be positioned above the food sheet with the grease agent so as to facilitate the distribution of the flavorings and/or seasonings to the pizza dough rather than the pan.

The food product may then be baked to completion and prepared for delivery to the customer (step 428). In some embodiments, this particular step may include packaging, boxing, freezing, and/or refrigerating the food product for delivery to the customer or for carrying to the customer for consumption in a restaurant. Thereafter, the method ends (step 432).

As a more specific but non-limiting example of the above-described method, a customer of a restaurant may have an allergy to black pepper and oregano. The customer may walk into the restaurant to order food. The restaurant operator may take the customer's order and note the customer's allergy restrictions by any number of means (e.g., manually, via an electronic interface, etc.). The customer's allergy restrictions may be transferred to a kitchen of the restaurant. In the kitchen, a chef may follow an appropriate food preparation process and may take the customer's allergy restriction into account in any number of ways (e.g. manually, automatically, etc.). An automated food sheet dispenser system may dispense food sheets for each of the spices needed for the order except items matching the customer's allergy restrictions (e.g., pepper and the oregano sheets) may be excluded. The system may also provide a mechanism to identify that allergy restrictions free batch with that customer's order to ensure the customer gets the correct dish (e.g., a dish that is free of the identified allergens). Thus, as can be seen in this example, the food preparation method 400 may be executed in connection with the preparation of pizza as a food product or in connection with any other type of food product without departing from the scope of the present disclosure.

With reference now to FIG. 5, yet another food preparation method 500 will be described in accordance with at least some embodiments of the present disclosure. This particular food preparation method may be used in connection with the preparation of food sheets 100 prior to the preparation of a food product. The method 500 begins at step 504 and continues by inserting one or more food sheets 100 into a grease agent deposition chamber (step 508). The grease agent deposition chamber may correspond to any environment that has a controllable temperature and/or pressure that is sufficient to enable the deposition of a grease agent onto or into a material of the food sheets 100.

In some embodiments, a plurality of food sheets 100 may be simultaneously placed into a grease agent deposition chamber so as to facilitate a higher production rate of food sheets with a grease agent provided thereon or therein. In some embodiments, a substrate having a fiber matrix of edible and/or dissolvable materials may be inserted into the grease agent deposition chamber. The fiber matrix may have an amount of space and/or gaps between the fibers of the matrix that are configured to receive a fluid or soluble mixture comprising a grease agent and, optionally, a flavoring and/or seasoning.

The method 500 continues by determining a grease agent deposition temperature and pressure. In some embodiments, the grease agent deposition temperature and/or pressure should be sufficient to enable flowing and/or vapor deposition of a grease agent, but not so as to disrupt the structural integrity of the food sheet 100 itself. Thus, if the food sheet 100 is configured to dissolve under application of heat above 190 degrees Fahrenheit, the grease agent deposition temperature may be less than this dissolving temperature (e.g., less than 190 degrees Fahrenheit). It may be necessary then to increase the deposition pressure to accommodate the distribution of the grease agent into the material of the food sheet 100. As a non-limiting example, the grease agent deposition temperature and pressure may correspond to any temperature less than or equal to 190 degrees Fahrenheit and any pressure greater than or equal to 2 atmospheres (e.g., approximately 29 pounds per square inch). In some embodiments, the food sheet 100 may be subjected to a low-pressure chemical vapor deposition process for a predetermined amount of time (e.g., at least 2 minutes) sufficient to impregnate the food sheet 100 with a predetermined amount of the grease agent.

Thereafter, the food sheet 100 may be exposed to the determined temperature and pressure for the predetermined amount of time (step 520). In some embodiments, this process may simply be performed for a predetermined amount of time. In some embodiments, a feedback control loop may be utilized to ensure that the predetermined amount of grease agent has been deposited onto the material of the food sheet 100.

After the food sheet 100 has been exposed to the predetermined deposition temperature and pressure, the food sheet 100 may be extracted from the grease agent deposition chamber (step 524) and then stored at a stabilized temperature and pressure until it is ready for use in connection with the preparation of a food product (step 528). In some embodiments, the stabilized temperature and pressure may correspond to a temperature that is less than the deposition temperature and less than the temperature at which the material of the food sheet dissolves. In some embodiments, the stabilized pressure may correspond to one atmosphere (e.g., approximately 14.5 pounds per square inch). In some embodiments, the stabilized temperature may correspond to a refrigerated temperature (e.g., between 32 degrees Fahrenheit and 45 degrees Fahrenheit) or a freezing temperature (e.g., at or below 32 degrees Fahrenheit). Thereafter, the method ends (step 532).

With reference now to FIG. 6, another food preparation method 600 will be described in accordance with at least some embodiments of the present disclosure. The method 600 begins at step 604 and continues when a food order is received (step 608). Similar to step 408, the food order may be received at a restaurant, at an order counter, at a POS terminal, at a mobile food-ordering application, etc.

In response to receiving the food order, the method may continue with determining an appropriate amount of grease agent, flavorings, and/or seasoning to incorporate into a food sheet 100 (step 612). This may result in the just-in-time preparation of a customized food sheet that is accommodates the order received in step 608.

The determined amounts of grease agent, flavorings, and/or seasonings may then be mixed into a common mixture, which may be in liquid form or provided as a soluble mixture (step 616). In some embodiments, discrete and measured amounts of the grease agent, flavorings, and seasonings may be first measured from individual hoppers or bins and then combined in a mixing chamber, for example. In an alternative implementation, the discrete amounts of ingredients may not be mixed prior to application, but rather may be mixed during application to the food sheet and/or food product (step 620). The discrete amounts of ingredients may come from separate sources, which are separated from one another, so as to avoid cross-contamination prior to application of the ingredients to the food sheet and/or food product. In some embodiments, the determined amounts of grease agent, flavorings, and/or seasonings may be applied to the food sheet 100 and/or food product with an inkjet application. In such an embodiment, discrete inkjet heads may apply different types of ingredients so as to ensure that only the desired ingredients are applied to the food sheet 100 and/or food product for the order. As a more specific, but non-limiting example, the desired ingredients may be sprayed with inkjet sprayers or printer heads, with each printer head applying a different ingredient to the food sheet and/or food product. Furthermore, it may be desirable to apply the desired ingredients to both the food sheet and food product to ensure that a proper amount of lubrication is achieved along with the proper amount of flavoring/seasoning.

The food product may then be prepared for baking and/or cooking (step 624). This step may include further preparation of the food product (e.g., by adding toppings to pizza, by adding other ingredients to the food product, etc.). The food product may then be baked with the mixture applied thereto (step 628). In some embodiments, during the baking step, the material of the food sheet 100 may dissolve or become absorbed into the food product and the contents of the grease agent and flavorings that were applied to the food sheet 100 may distribute across the food product and/or provide a lubrication between the food product and a baking dish. Thereafter, the method ends (step 632).

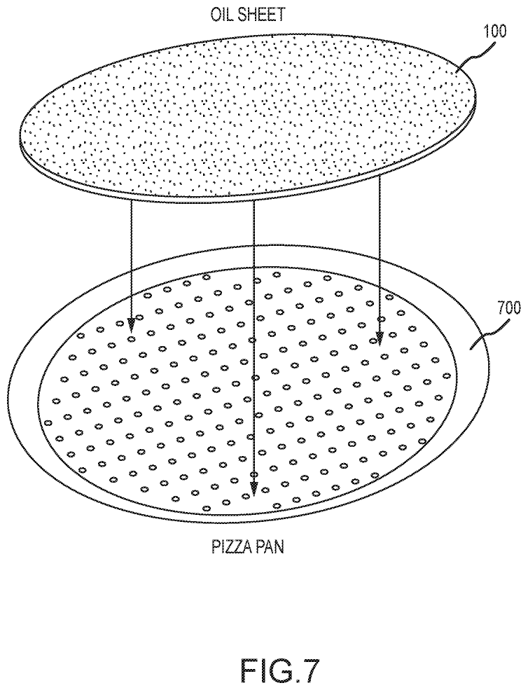

As can be seen in FIG. 7, the food sheet 100 may be provided in a circular, elliptical, or other rounded shape that substantially conforms or matches a baking vessel, such as a pizza pan 700. In some embodiments, the food sheet 100 may be pre-formed to this particular size and shape or the food sheet 100 may be configured to be cut to the desired shape during the food preparation process.

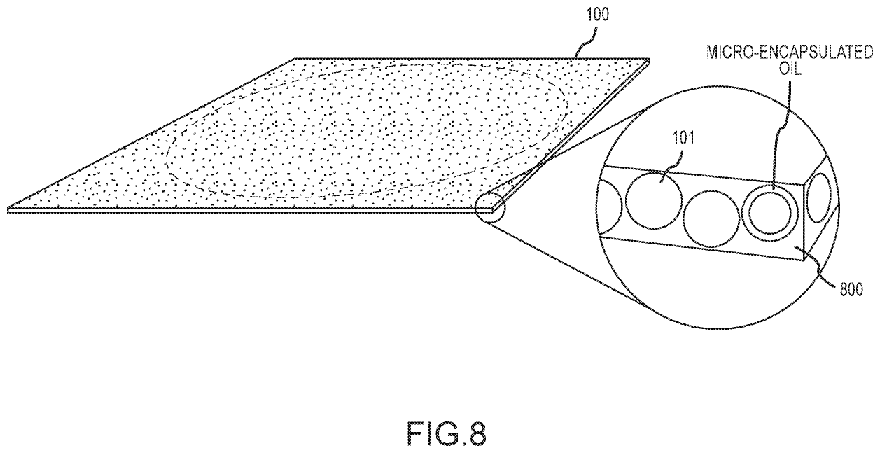

FIG. 8 illustrates another possible configuration of the food sheet 100 whereby the food sheet 100 itself exhibits a non-circular or rounded shape, but is sufficiently sized to receive a round or circular food product, such as pizza dough, cookies, etc. FIG. 8 also illustrates additional details of the food sheet 100. In some embodiments, the food sheet 100 may include the capsules 101 as described above and the capsules may contain a grease agent, flavoring, and/or seasoning as described above. The capsules 101, in this depicted embodiment, are shown to be suspended within support material 800, which may provide the desired structure to support the capsules 101. The material used for the support material 800 may be different from the material used for the capsules 101. As a non-limiting example, the support material 800 may be constructed of a dissolvable and/or edible material such as a mixture of starch, agar, grain, rice, fruit, and vegetable. The capsules 101, on the other hand, may be constructed of a gelatin material, which may or may not have the same dissolving properties as the support material 800.

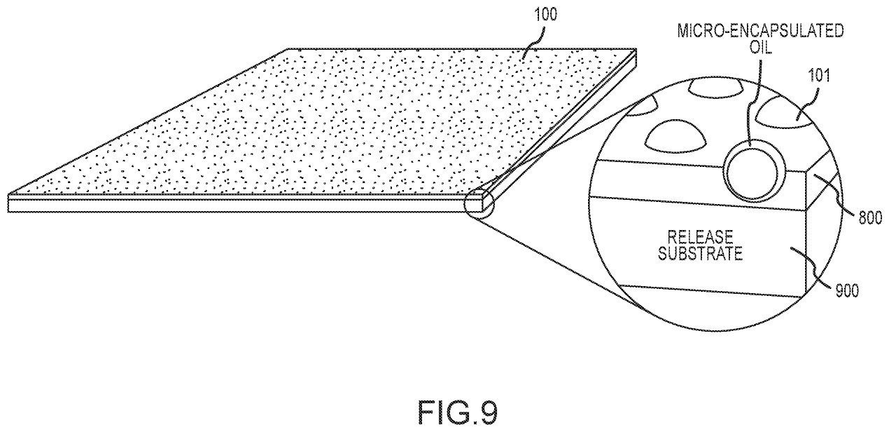

FIG. 9 exhibits a further enhancement to a food sheet 100 in which the support material 800 is further supported by a release substrate or release film 900. In some embodiments, the support material 800 may contain the capsules 101 and both the support material 800 and capsules 101 may be supported by the release substrate or film 900. In some embodiments, the release substrate or film 900 may correspond to a known type of baking product, such as wax paper or the like.

FIG. 9 further illustrates the possibility of having at least some of the capsule surface 101 exposed from the support material 800. In some embodiments, a portion of the capsule surface 101 may be surrounded by and, therefore, supported by the support material 800; however, another portion of some capsules 101 may be exposed and not surrounded by the support material 800. In this way, the contents of the capsules 101 may be released prior to the entirety of the support material 800 dissolving. This may be desirable for a number of reasons. As one example, it may be desirable to provide a food sheet 100 that is specifically designed, engineered and manufactured to provide varying degrees of texture or crunchiness to an outer food surface by precisely controlling the total amount of oil (or other substance) that is contained on/in a food sheet for a specific application. This control over the food sheet 100 ultimately control the results of the food product when cooked, baked, etc. Thus, in some embodiments, the amount of the capsule's 101 surface that is exposed beyond the support material 800 may adjust how quickly the contents of the capsules are released (e.g., at what baking temperature the materials become released) and how much of the materials are released. Modifying the depth at which the capsules 101 are buried within the support material 800 in addition to modifying the contents and amounts of contents contained within the capsules 101 may have substantially different effects on the food product during cooking, baking, or the like.

In some embodiments, it may be desirable to provide one type of food sheet 100 for one type of food product preparation (e.g., deep-dish pizza) and another type of food sheet 100 for another type of food product preparation (e.g., thin crust pizza). In some embodiments, the nature of the food sheets 100 for different applications or food products may be predefined or modified in real-time, in response to the order. For instance, a customer ordering a crisper crust may have a different food sheet 100 used in the preparation of their food product as compared to another customer ordering a chewier crust.

A food sheet 100 can also (or instead), be specifically designed, engineered and manufactured to provide slow, medium or fast release of the lubricating/grease agent by tailoring variables like carrier and/or base composition, thickness and melting/ dissolving profile. By comparison, pouring, spraying, and rubbing oil (or other cooking and flavoring aides) provides very poor control over amount and no control over release rate, which can contribute to inconsistent results in food quality and limited flexibility in food preparation customer preferences, especially in the quick-serve and fast-casual food industry where a chef or very experienced cook is not overseeing food preparation.

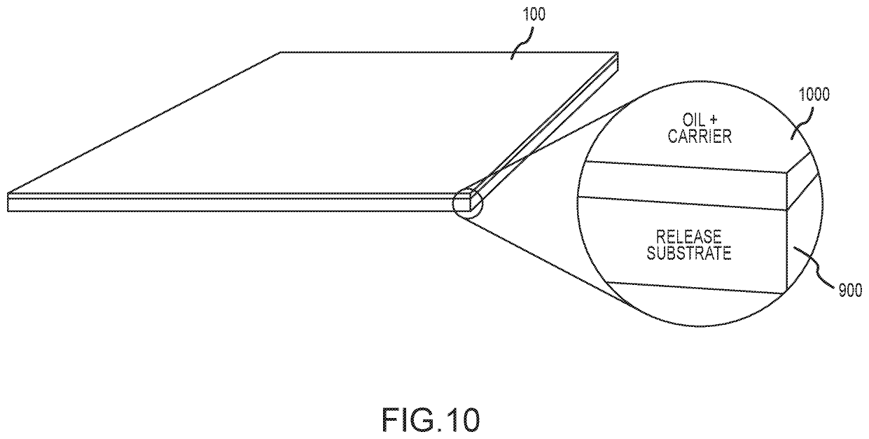

FIG. 10 shows yet another embodiment of the food sheet 100 where the release substrate or film 900 supports the oil and carrier matrix 1000. The oil and carrier matrix 1000 may be similar or identical to the food sheets discussed herein above where the fibers of a consumable and dissolvable base material are impregnated or coated with the grease agent (and possibly a flavoring and/or seasoning).

As discussed above, the various methods of food preparation may be suitable in connection with pizza preparation; however, embodiments of the present disclosure are not intended to be limited to the preparation of pizza as a food product. Rather, embodiments of the present disclosure are intended to apply to the preparation of any food product, which may be baked, cooked, steamed, etc. Embodiments of the present disclosure also contemplate application in food preparation methods where no baking, cooking, or other application of heat is used during food preparation, but rather moisture is the sole mechanism for dissolving the food sheet 100.

The above-described methods may be used to enable a consumers customize a layering of flavorings and food texture imparted by “crusting” techniques. For example, macadamia crusted mahi-mahi, parmesan crusted chicken breast, etc. may all be selected by a customer as a particular finish for their food order and the food order can be accommodate with a food sheet or combination of appropriate food sheets in real-time. It should also be appreciated that different levels of “crispiness” or “crunchiness” can be imparted to the outer surface of the food product, whether pizza or other.

In some embodiments, a customer could specify “crusting” ingredients that they would like to have “embedded” into the outer layer of their food and/or also specify the level of crispiness or crunchiness they would like. As discussed above, a “composite” food sheet (e.g., a stack of food sheets) could then be assembled by the cooks to impart the desired flavors and textures by layering very thin, low-cost food sheets with the desired amount and type of active ingredients.

Among other things, this provides the benefit of imparting very precise control and could even lend itself to customers saving their own favorite combinations on an application-based interface for that menu item at a restaurant brand.

It should also be appreciated that, in some embodiments, the customized/ composite food sheet does not necessarily need to cover the complete outer surfaces of the food item. Instead, the composite food sheet could be shaped like a ring corresponding to the outer 2″ of the circumference of a pizza and could be placed on the top surface, lower surface or both. The placement of a food sheet or multiple food sheets in this way could impart different depths of flavors and textures on the upper and lower surfaces of a steak, chicken breast, etc.

As a non-limiting example, a user may seek to cook a chicken broth soup or liquid. The user may select a chicken broth-flavored food sheet 100. The chicken broth-flavored food sheet may include a base of ingredients that are chicken-base-tasting ingredients. The user may place a portion of such a chicken broth-flavored food sheet in water. The ratio of food sheet to water may depend on the level of flavor the user seeks. The temperature water may depend on the level of flavor the user seeks. The food sheet may dissolve in the water and may transfer the taste and flavor of chicken into the water.

In another illustrative embodiment, a user may seek to cook a rack of ribs on a barbecue grill. The user may seek to flavor the rack of ribs with a sweet and sour mix of ingredients. The user may then select any number of food sheets that may provide a flavor profile with which the user would like the rack of ribs to be flavored. For example, the user may select one food sheet of sweet flavors, one sheet of smoked oak flavors, and one sheet of a lemon sour flavor. The user's goal in selecting the sheets making up the mix of sheets may be to obtain a satisfactory resulting flavor profile. The user may place each sheet on the top of the rack of ribs before, during, or after barbecuing the ribs. The food sheets chosen by the user may then dissolve onto the ribs and transfer the taste and flavors to the ribs.

In another illustrative embodiment, a user may seek to add a cherry flavor to his or her drink (e.g. water or soda). The user may take a cherry flavored food sheet and simply add it to the liquid of the drink. The food sheet may then dissolve and impart a cherry flavor profile to the drink.

What is claimed is:

1. A food sheet for use in preparation of a food product, the food sheet comprising:
a base material that is dissolvable at a predetermined environmental condition; and
a grease agent contained within the base material, wherein the grease agent is released from the base material when the base material dissolves and then provides a baking or cooking lubrication for the food product.

2. The food sheet of claim 1, wherein the base material comprises a plurality of capsules, at least some of which encapsulate a discrete amount of the grease agent and release the grease agent upon dissolving.

3. The food sheet of claim 2, further comprising:
at least one of a food flavoring and seasoning that is incorporated into the base material.

4. The food sheet of claim 3, wherein the at least one of food flavoring and seasoning is encapsulated in capsules that do not contain the grease agent.

5. The food sheet of claim 3, wherein the at least one of food flavoring and seasoning is encapsulated in the at least some capsules that also contain the grease agent.

6. The food sheet of claim 3, wherein the plurality of capsules are distributed in an array and predetermined proportions of the grease agent relative to the at least one of food flavoring and seasoning provided by the food sheet is achieved by distributing a first predetermined amount of the grease agent to some of the plurality of capsules and distributing a second predetermined amount of the at least one of flavoring and seasoning to others of the plurality of capsules.

7. The food sheet of claim 6, wherein the first predetermined amount of the grease agent is different from the second predetermined amount of the at least one of flavoring and seasoning.

8. The food sheet of claim 1, wherein the base material is edible and wherein the plurality of capsules are embedded in and distributed throughout an edible substrate that is supported by the base material.

9. The food sheet of claim 1, wherein the base material comprises one or more of a starch, gelatin, agar, grain, rice, fruit, and vegetable.

10. The food sheet of claim 1, wherein the base material comprises a fiber matrix and wherein the grease agent is deposited into the fiber matrix.

11. The food sheet of claim 1, wherein the grease agent is deposited into the fiber matrix via vapor deposition.

12. The food sheet of claim 1, wherein the base material comprises a plurality of perforations at predetermined intervals to accommodate different sizes of a food sheet to be prepared based on a size of the food product.

13. The food sheet of claim 1, wherein the predetermined environmental condition comprises a temperature of at least 190 degrees Fahrenheit.

14. The food sheet of claim 1, wherein the predetermined environmental condition comprises exposure to moisture from the food product and wherein the base material dissolved into the food product at the predetermined environmental condition.

15. The food sheet of claim 1, wherein the grease agent provides a baking or cooking lubrication between the food product and a baking vessel on which the food product is baked or cooked at the predetermined environmental condition.

16. A method of preparing a food product, comprising:
receiving a food order with allergy information;
identifying at least one sheet that contains an allergen consistent with the allergy information;
distributing one or more food sheets in connection with preparing the food product, wherein the distributed one or more food sheets do not include the identified at least one sheet that contains the allergen;
positioning the distributed one or more food sheets between the food product and a baking vessel; and
exposing the food product and the one or more food sheets to a predetermined environmental condition.

17. The method of claim 16, further comprising:
indicating that the food product is devoid of the allergen based on the failure to include the identified at least one sheet in the distributed one or more sheets.

18. The method of claim 16, wherein the distributed one or more food sheets comprise at least one of a grease agent, a flavoring, and a seasoning.

19. The method of claim 18, wherein the distributed one or more food sheets each comprise a base material that is dissolvable at the predetermined environmental condition and wherein the at least one of the grease agent, the flavoring, and the seasoning is released from the base material when the base material dissolves.

20. The method of claim 19, wherein the base material comprises a plurality of capsules, at least some of which encapsulate a discrete amount of the at least one of the grease agent, the flavoring, and the seasoning.

21. The method of claim 16, wherein the distributed one or more food sheets comprise a first food sheet containing a grease agent and a second food sheet containing a flavoring or seasoning, wherein the first food sheet is positioned closer to the baking vessel than the second food sheet.

22. The method of claim 16, wherein the distributed one or more food sheets are maintained at a refrigeration temperature or a freezing temperature prior to being distributed.

23. The method of claim 16, wherein the predetermined environmental condition comprises a baking temperature.

24. A method of preparing a food sheet, comprising:
inserting a food sheet into a grease agent deposition chamber;
exposing the food sheet to a predetermined grease agent deposition temperature and pressure sufficient to deposit a grease agent into the food sheet; and
extracting the food sheet from the grease agent deposition chamber after the food sheet has been exposed to the predetermined grease agent deposition temperature and pressure for a predetermined amount of time or after a predetermined amount of the grease agent has been deposited into the food sheet.

25. The method of claim 24, wherein the food sheet comprises a fiber matrix with voids that are at least partially filled by the grease agent during exposure to the predetermined grease agent deposition temperature and pressure.

26. The method of claim 24, wherein the predetermined grease agent deposition temperature and pressure comprises a temperature and pressure at which a structural integrity of the food sheet is maintained, but at which the grease agent is in a fluid, soluble, or vapor state.

27. The method of claim 24, wherein the predetermined grease agent deposition temperature and pressure comprises a temperature less than a temperature at which the food sheet dissolves.

28. The method of claim 27, wherein the predetermined grease agent deposition temperature and pressure comprises a pressure that is greater than atmospheric pressure.

29. The method of claim 24, further comprising:
incorporating a flavoring or seasoning into the grease agent.
